(19) United States
(12) Patent Application Publication
(10) Pub. No.: US 2013/0114900 A1
(43) Pub. Date: May 9, 2013

(54) METHODS AND APPARATUSES FOR MOBILE VISUAL SEARCH

(71) Applicants: Ramakrishna Vedantham, Sunnyvale, CA (US); Radek Grzeszczuk, Menlo Park, CA (US); David Mo Chen, Mountain View, CA (US); Shang-Hsuan Tsai, Stanford, CA (US); Bernd Griod, Stanford, CA (US)

(72) Inventors: Ramakrishna Vedantham, Sunnyvale, CA (US); Radek Grzeszczuk, Menlo Park, CA (US); David Mo Chen, Mountain View, CA (US); Shang-Hsuan Tsai, Stanford, CA (US); Bernd Griod, Stanford, CA (US)

(73) Assignees: Stanford University, Stanford, CA (US); Nokia Corporation, Espoo (FI)

(21) Appl. No.: 13/290,658

(22) Filed: Nov. 7, 2011

(51) Int. Cl. G06K 9/18

(52) U.S. Cl. 382/182

(57) ABSTRACT

Methods, apparatuses, and computer program products are herein provided for providing a REVV system that is configured to provide an MVS that is operable on a mobile terminal. One example method may include causing a plurality of vector word residuals to be aggregated for at least one visual word using local feature descriptors extracted from an image. The method may further include causing the dimensionality of the aggregated at least one vector word residual for each visual word to be reduced by using a classification aware linear discriminant analysis. The method may further include computing, using a processor, a weighted correlation for at least one compact image signature that is binarized from the aggregated at least one vector word residual when compared to a list of candidates. The method may further include determining a ranked list of candidates based on the computed weighted correlation.

### TECHNOLOGICAL FIELD

Embodiments of the present invention relate generally to visual search technology and, more particularly, relate to a method, apparatus, and computer program product for facilitating visual search using a mobile terminal.

### BACKGROUND

As the capabilities and processing power of mobile terminals continues to grow, mobile terminals are increasingly used for a multitude of services previously reserved for larger and less mobile devices. One such service may include visual search and recognition based on a captured image.

Mobile visual search (MVS) refers to a category of image recognition services where a user may capture a picture of an object in order to receive useful information about that object. MVS may, for example, be used for recognition of outdoor landmarks, product covers, wine labels, printed documents and/or the like.

Generally MVS systems employ large remote databases that house a plurality of images, captured media, video and/or the like used in a visual based search. In order to search the large remote database to find visually similar examples relative to a user-generated query image, a vocabulary tree (VT) is commonly used. A VT allows for fast comparisons between a query image and a large database of images. Generally several gigabytes of random access memory (RAM) are required to represent the various data structures and image signatures associated with a VT. Remote servers are generally used for such a purpose because they have a large amount of RAM available and can tolerate the large memory and storage requirements of the typical visual search system. Each of these prior systems depended on large amounts of memory and processing power to ensure a high level of accuracy when performing visual search.

### BRIEF SUMMARY

Methods, apparatuses, and computer program products herein provide for a compact residual enhanced visual vector (REVV) system that is configured to enable an on-device (e.g. mobile terminal) MVS. The example REVV according to some embodiments of the present invention, may be configured to form a compact image signature for a query image and then compare the compact image signature against image signatures stored in a local database to produce a ranked list of candidates. The systems and methods as described herein then may cause the ranked list of candidates to be displayed on a user interface and/or to retrieve useful information about the top-ranked candidates

In one embodiment, a method is provided that comprises causing a plurality of vector word residuals to be aggregated for at least one visual word using local feature descriptors extracted from an image. The method of this embodiment may also include causing the dimensionality of the aggregated at least one vector word residual for each visual word to be reduced by using a classification aware linear discriminant analysis. The method of this embodiment may also include computing, using a processor, a weighted correlation for at least one compact image signature that is binarized from the aggregated at least one vector word residual when compared to a list of candidates. The method of this embodiment may also include determining a ranked list of candidates based on the computed weighted correlation.

In another embodiment, an apparatus is provided that includes at least one processor and at least one memory including computer program code with the at least one memory and the computer program code being configured, with the at least one processor, to cause the apparatus to at least cause a plurality of vector word residuals to be aggregated for at least one visual word using local feature descriptors extracted from an image, wherein the vector word residuals are aggregated based on a mean, median or the like of the vector word residuals. The at least one memory and computer program code may also be configured to, with the at least one processor, cause the apparatus to cause the dimensionality of the aggregated at least one vector word residual for each visual word to be reduced by using a classification aware linear discriminant analysis. The at least one memory and computer program code may also be configured to, with the at least one processor, cause the apparatus to compute, using a processor, a weighted correlation for at least one compact image signature that is binarized from the aggregated at least one vector word residual when compared to a list of candidates. The at least one memory and computer program code may also be configured to, with the at least one processor, cause the apparatus to determine a ranked list of candidates based on the computed weighted correlation.

In the further embodiment, a computer program product may be provided that includes at least one non-transitory computer-readable storage medium having computer-readable program instruction stored therein with the computer-readable program instructions including program instructions configured to cause a plurality of vector word residuals to be aggregated for at least one visual word using local feature descriptors extracted from an image, wherein the vector word residuals are aggregated based on a mean, median or the like of the vector word residuals. The computer-readable program instructions may also include program instructions configured to cause the dimensionality of the aggregated at least one vector word residual for each visual word to be reduced by using a classification aware linear discriminant analysis. The computer-readable program instructions may also include program instructions configured to compute, using a processor, a weighted correlation for at least one compact image signature that is binarized from the aggregated at least one vector word residual when compared to a list of candidates. The computer-readable program instructions may also include program instructions configured to determine a ranked list of candidates based on the computed weighted correlation.

In yet another embodiment, an apparatus is provided that includes means for causing a plurality of vector word residuals to be aggregated for at least one visual word using local feature descriptors extracted from an image. The apparatus of this embodiment may also include means for causing the dimensionality of the aggregated at least one vector word residual for each visual word to be reduced by using a classification aware linear discriminant analysis. The apparatus of this embodiment may also include means for computing, using a processor, a weighted correlation for at least one compact image signature that is binarized from the aggregated at least one vector word residual when compared to a list of candidates. The apparatus of this embodiment may also include means for determining a ranked list of candidates based on the computed weighted correlation.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates an example block diagram of an example visual search apparatus according to an example embodiment of the present invention;

FIG. 2 is an example schematic block diagram of an example mobile terminal according to an example embodiment of the present invention;

FIG. 3 illustrates example Voronoi cells, visual words or centroids, image features, and word residual vectors according to an example embodiment of the invention;

FIG. 4 illustrates an example user interface according to an example embodiment of the invention;

FIG. 5 illustrates an example visual search system according to an example embodiment of the present invention; and

FIG. 6 illustrates a flowchart according to an example method for visual search according to an example embodiment of the invention.

### DETAILED DESCRIPTION

Example embodiments will now be described more fully hereinafter with reference to the accompanying drawings, in which some, but not all embodiments are shown. Indeed, the embodiments may take many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments, to refer to data capable of being transmitted, received, operated on, and/or stored. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

As used herein, the term “circuitry” refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in a server, a cellular network device, or other network device.

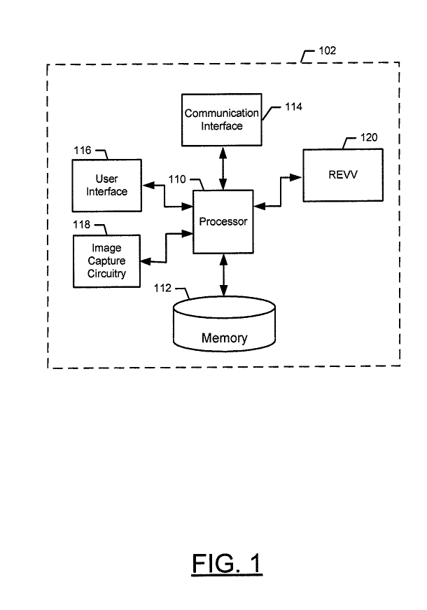

FIG. 1 illustrates a block diagram of a visual search apparatus 102 for an MVS system using REVV that is configured to use an image or a series of images (e.g. media clip, video, video stream and/or the like) to search a database of images or series of images according to an example embodiment of the present invention. The example REVV of FIG. 1 is advantageously configured to perform MVS by providing residual aggregation using a mean, median or the like type aggregation. The example REVV is further configured to perform outlier rejection, by discarding unstable features during vector quantization. The example REVV may also perform classification-aware dimensionality reduction, using linear discriminant analysis in place of principal component analysis. The example REVV may further perform discriminative weighting based on correlation between image signatures in the compressed domain. Advantageously, with these enhancements, for example, REVV attains similar retrieval performance as a VT, while using less memory than a VT with both uncompressed and compressed inverted indices.

It will be appreciated that the visual search apparatus 102 is provided as an example of one embodiment of the invention and should not be construed to narrow the scope or spirit of the invention in any way. In this regard, the scope of the disclosure encompasses many potential embodiments in addition to those illustrated and described herein. As such, while FIG. 1 illustrates one example of a configuration of an apparatus for MVS other configurations may also be used to implement embodiments of the present invention.

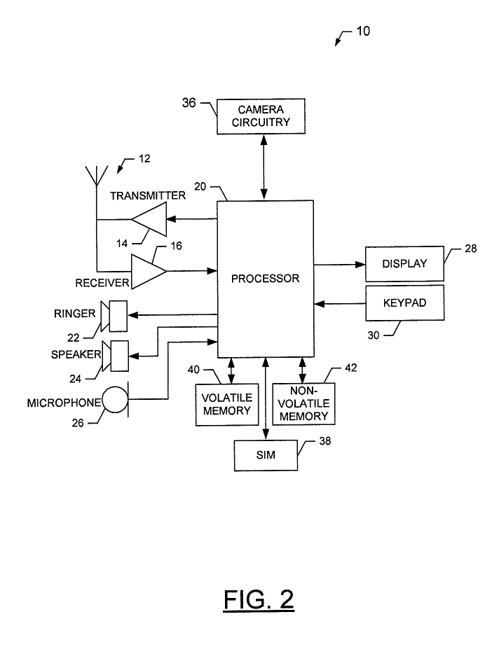

The visual search apparatus 102 may be embodied as a desktop computer, laptop computer, mobile terminal, mobile computer, tablet, mobile phone, mobile communication device, one or more servers, one or more network nodes, game device, digital camera/camcorder, audio/video player, television device, radio receiver, digital video recorder, positioning device, any combination thereof, and/or the like. In an example embodiment, the visual search apparatus 102 may be embodied as a mobile terminal, such as that illustrated in FIG. 2.

In this regard, FIG. 2 illustrates a block diagram of a mobile terminal 10 representative of one embodiment of a visual search apparatus 102. It should be understood, however, that the mobile terminal 10 illustrated and hereinafter described is merely illustrative of one type of visual search apparatus 102 that may implement and/or benefit from embodiments of the present invention and, therefore, should not be taken to limit the scope of the present invention. While several embodiments of the mobile terminal (e.g., mobile terminal 10) are illustrated and will be hereinafter described for purposes of example, other types of mobile terminals, such as mobile telephones, mobile computers, portable digital assistants (PDAs), pagers, laptop computers, desktop computers, gaming devices, televisions, and other types of electronic systems, may employ embodiments of the present invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wireless-Fidelity (Wi-Fi), wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal 10 may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wireless Fidelity (Wi-Fi) or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal 10 may be allocated between these devices according to their respective capabilities. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

The mobile terminal 10 may include a media capturing element, such as a camera, video and/or audio module, in communication with the processor 20. The media capturing element may comprise any means for capturing an image, video and/or audio for visual search, storage, display or transmission. For example, in an example embodiment in which the media capturing element comprises camera circuitry 36, the camera circuitry 36 may include a digital camera configured to form a digital image file from a captured image. In addition, the digital camera of the camera circuitry 36 may be configured to capture a video clip. As such, the camera circuitry 36 may include all hardware, such as a lens or other optical component(s), and software necessary for creating a digital image file from a captured image as well as a digital video file from a captured video clip. Alternatively, the camera circuitry 36 may include only the hardware needed to view an image, while a memory device of the mobile terminal 10 stores instructions for execution by the processor 20 in the form of software necessary to create a digital image file from a captured image. As yet another alternative, an object or objects within a field of view of the camera circuitry 36 may be displayed on the display 28 of the mobile terminal 10 to illustrate a view of an image currently displayed which may be captured if desired by the user. As such, a captured image may, for example, comprise an image captured by the camera circuitry 36 and stored in an image file. As another example, a captured image may comprise an object or objects currently displayed by a display or viewfinder of the mobile terminal 10, but not necessarily stored in an image file. In an example embodiment, the camera circuitry 36 may further include a processing element such as a co-processor configured to assist the processor 20 in processing image data and an encoder and/or decoder for compressing and/or decompressing image data. The encoder and/or decoder may encode and/or decode according to, for example, a joint photographic experts group (JPEG) standard, a moving picture experts group (MPEG) standard, or other format.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include other non-transitory memory, such as volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 1, in an example embodiment, the visual search apparatus 102 includes various means for performing the various functions herein described. These means may comprise one or more of a processor 110, memory 112, communication interface 114, user interface 116, image capture circuitry 118, and/or a REVV module 120. The means of the visual search apparatus 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 112) that is executable by a suitably configured processing device (e.g., the processor 110), or some combination thereof.

The processor 110 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC or FPGA, or some combination thereof. Accordingly, although illustrated in FIG. 1 as a single processor, in some embodiments the processor 110 comprises a plurality of processors. The plurality of processors may be in operative communication with each other and may be collectively configured to perform one or more functionalities of the visual search apparatus 102 as described herein. The plurality of processors may be embodied on a single computing device or distributed across a plurality of computing devices collectively configured to function as the visual search apparatus 102. In embodiments wherein the visual search apparatus 102 is embodied as a mobile terminal 10, the processor 110 may be embodied as or comprise the processor 20. In an example embodiment, the processor 110 is configured to execute instructions stored in the memory 112 or otherwise accessible to the processor 110. These instructions, when executed by the processor 110, may cause the visual search apparatus 102 to perform one or more of the functionalities as described herein. As such, whether configured by hardware or software methods, or by a combination thereof, the processor 110 may comprise an entity capable of performing operations according to embodiments of the present invention while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may comprise, for example, non-transitory memory, such as volatile memory, non-volatile memory, or some combination thereof. Although illustrated in FIG. 1 as a single memory, the memory 112 may comprise a plurality of memories. The plurality of memories may be embodied on a single computing device or may be distributed across a plurality of computing devices collectively configured to function as the visual search apparatus 102. In various example embodiments, the memory 112 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the visual search apparatus 102 is embodied as a mobile terminal 10, the memory 112 may comprise the volatile memory 40 and/or the non-volatile memory 42. The memory 112 may be configured to store information, data, applications, instructions, or the like for enabling the visual search apparatus 102 to carry out various functions in accordance with various example embodiments. For example, in at least some embodiments, the memory 112 is configured to buffer input data for processing by the processor 110. Additionally or alternatively, in at least some embodiments, the memory 112 is configured to store program instructions for execution by the processor 110. The memory 112 may store information in the form of static and/or dynamic information. The stored information may include, for example, models used for visual search and/or the like. This stored information may be stored and/or used by the image capture circuitry 118 and/or a REVV module 120 during the course of performing their functionalities. The memory 112 may also be configured to store a database of one or more images and/or images signatures that are accessible by the REVV module 120. The database may be updated based on allocation, time or the like using the communications interface 114.

The communication interface 114 may be embodied as any device or means embodied in circuitry, hardware, a computer program product comprising computer readable program instructions stored on a computer readable medium (e.g., the memory 112) and executed by a processing device (e.g., the processor 110), or a combination thereof that is configured to receive and/or transmit data to/from another computing device. For example, the communication interface 114 may be configured to receive data representing an image over a network. In this regard, in embodiments wherein the visual search apparatus 102 comprises a server, network node, or the like, the communication interface 114 may be configured to communicate with a remote mobile terminal (e.g., the remote terminal 304) to allow the mobile terminal and/or a user thereof to access visual search functionality provided by the visual search apparatus 102. In an example embodiment, the communication interface 114 is at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with one or more remote computing devices. The communication interface 114 may be configured to receive and/or transmit data using any protocol that may be used for communications between computing devices. In this regard, the communication interface 114 may be configured to receive and/or transmit data using any protocol that may be used for transmission of data over a wireless network, wireline network, some combination thereof, or the like by which the visual search apparatus 102 and one or more computing devices are in communication. The communication interface 114 may additionally be in communication with the memory 112, user interface 116, image capture circuitry 118, and/or a REVV module 120, such as via a bus.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touch screen display, a microphone, a speaker, and/or other input/output mechanisms. In embodiments wherein the visual search apparatus 102 is embodied as one or more servers, aspects of the user interface 116 may be reduced or the user interface 116 may even be eliminated. The user interface 116 may be in communication with the memory 112, communication interface 114, image capture circuitry 118, and/or a REVV module 120, such as via a bus.

The image capture circuitry 118 may be embodied as various means, such as circuitry, hardware, a computer program product comprising computer readable program instructions stored on a computer readable medium (e.g., the memory 112) and executed by a processing device (e.g., the processor 110), or some combination thereof and, in one embodiment, is embodied as or otherwise controlled by the processor 110. In embodiments wherein the image capture circuitry 118 is embodied separately from the processor 110, the image capture circuitry 118 may be in communication with the processor 110. The image capture circuitry 118 may further be in communication with one or more of the memory 112, communication interface 114, user interface 116, and/or a REVV module 120, such as via a bus.

The image capture circuitry 118 may comprise hardware configured to capture an image. In this regard, the image capture circuitry 118 may comprise a camera lens, IR lens and/or other optical components for capturing a digital image. As another example, the image capture circuitry 118 may comprise circuitry, hardware, a computer program product, or some combination thereof that is configured to direct the capture of an image by a separate camera module embodied on or otherwise operatively connected to the visual search apparatus 102. In embodiments wherein the visual search apparatus 102 is embodied as a mobile terminal 10, the image capture circuitry 118 may comprise the camera circuitry 36. In embodiments wherein the visual search apparatus 102 is embodied as one or more servers or other network nodes remote from a mobile terminal configured to provide an image or video to the visual search apparatus 102 to enable the visual search apparatus 102 to perform visual search on the image or video, aspects of the image capture circuitry 118 may be reduced or the image capture circuitry 118 may even be eliminated.

The REVV module 120 may be embodied as various means, such as circuitry, hardware, a computer program product comprising computer readable program instructions stored on a computer readable medium (e.g., the memory 112) and executed by a processing device (e.g., the processor 110), or some combination thereof and, in one embodiment, is embodied as or otherwise controlled by the processor 110. In embodiments wherein the REVV module 120 is embodied separately from the processor 110, the REVV module 120 may be in communication with the processor 110. The REVV module 120 may further be in communication with one or more of the memory 112, communication interface 114, user interface 116, and/or image capture circuitry 118, such as via a bus.

The REVV module 120 may be configured to form a compact image signature for a queried image and then compare the compact image signature with a database of image signatures, such as for example image signatures stored in the memory 112. In some embodiments, the compact image signature is generated by binarizing a set of aggregated and dimension-reduced word residuals.

In some example embodiments, the REVV module 120 is configured to quantize one or more local feature descriptors extracted from an image to a closest vector word. A predetermined number (e.g. 128) of vector words may be stored for example in the memory 112. A local feature may then have a vector word residual that may be the difference between the local feature descriptor and the closest vector word. The vector word residual may then by aggregated by discarding outlier local feature outlier residuals; by computing a vector mean, median or the like among the vector word residuals; and/or by applying power law regularization.

In further example embodiments, the REVV module 120 may cause the dimensionality of the vector word to be reduced by performing linear discriminant analysis (LDA) (e.g. transform that considers classification performance) and further the vector word residuals may be binarized. Hamming distances between binarized signatures may be computed using bitwise XOR and/or POPCOUNT operations. The distances may then be weighted according to a matching/non-matching likelihood ratio to further enhance the discriminative capability of a REVV image signature.

In some example embodiments, the REVV module 120 may be configured to aggregate vector word residuals. For example, Let c₁, . . . ck be a set of d-dimensional visual words. After each descriptor in an image is quantized to the nearest visual word, a set of vector word residuals may then surround each visual word. For example, let NN(cᵢ) represent the set of residuals around the i-th visual word. To aggregate the residuals, several different approaches are possible, for example:

Sum aggregation: Here, the aggregated residual for the i-th visual word may be represented as:

$${a}_{i} = {\sum }_{v ∈ NN ( {c}_{i} )} v$$

Mean aggregation: in some example embodiments, the sum of residuals is normalized by the cardinality of NN(cᵢ) so the aggregated residual becomes:

$${a}_{i} = \frac{1}{\vert NN ( {c}_{i} ) \vert} {\sum }_{v ∈ NN ( {c}_{i} )} v$$

Median aggregation: in some example embodiments, the median may be determined along each dimension:

aᵢ(n)=median(v(n):vεNN(cᵢ))

For example by using mean, median or the like type aggregation, a plurality of vector word residuals for at least one visual word may be aggregated by using local feature descriptors extracted from an image. In some example embodiments, S may be the concatenation of aggregated word residuals: S=[a₁ . . . aₖ]. The image signature S̅ may then be formed as S̅=S/∥S∥₂. To compare two normalized images signatures S̅_{q} and S̅_{d}, their Euclidean distance ∥ S̅_{q}− S̅_{d}∥ may be computed, such as by the processor 110, or equivalently the inner product [symbol] S̅_{q}, S̅_{d} [symbol] may also be computed.

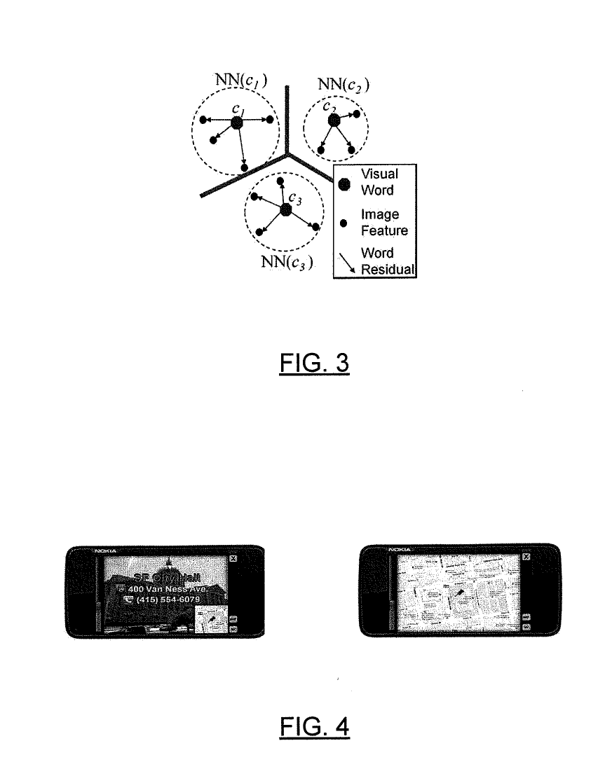

In some example embodiments, the REVV module 120 may be configured to reject outlier features. For example, some features that lie close to the boundary between two Voronoi cells reduce the repeatability of the aggregated residuals. By way of further example, the feature that lies very near the boundary between the Voronoi cells of c₁ and c₃ in FIG. 3. For example, even a small amount of noise can cause this feature to be quantized to c₃ instead of c₁, which would significantly change the composition of NN(c₁) and NN(c₃) and consequently the aggregated residuals a₁ and a₃.

Thus, the REVV module 120 may be configured to remove the outlier feature, for example by removing those features that are farthest away from the visual word. Alternatively or additionally those features that are past a predefined threshold such as a percentile may also be removed. By removing the features whose distance is above the C-th percentile on a distribution of distances most of the outlier features may be removed. In some example embodiments, the C-th percentile level is different for the various visual words, because the distance distributions are generally different, so a different threshold may be used for each visual word.

In some example embodiments, the REVV module 120 may be configured to apply a power law to the visual word residuals. In those embodiments were a power law is applied, a value for the exponent a in the power law may be α=0.4.

The REVV module 120 may also be configured to cause the dimensionality of the aggregated at least one vector word residual for each visual word to be reduced by using a classification aware LDA. For example, with LDA the image signature's dimensionality may be reduced in half, while actually boosting the retrieval performance. Since the residual vector's dimensionality is proportional to the size of the database index, the dimensionality may need to be reduced without adversely impacting retrieval performance. In some example embodiments, a different LDA transform is applied for each visual word. For example in order to maximize the ratio of inter-class variance to inter-class variance over the projection direction w, the following equation may be used:

$${S}_{j} = word residual from image j$$

$${J}_{M} = \{ ( {j}_{1} , {j}_{2} ) : images {j}_{1} and {j}_{2} are matching \}$$

$${J}_{NM} = \{ ( {j}_{1} , {j}_{2} ) : images {j}_{1} and {j}_{2} are non \text{-} matching )$$

$${maximize}_{w} \frac{{\sum }_{( {j}_{1} , {j}_{2} ) ∈ {J}_{NM}} {( {w}^{T} ( {S}_{{j}_{1}} - {S}_{{j}_{2}} ) )}^{2}}{{\sum }_{( {j}_{1} , {j}_{2} ) ∈ {J}_{M}} {( {w}^{T} ( {S}_{{j}_{1}} - {S}_{{j}_{2}} ) )}^{2}}$$

To reduce the dimensionality, the following solution may be used in some example embodiments:

$${R}_{NM} {w}_{i} = {λ}_{i} {R}_{M} {w}_{i}$$

$$i = 1 , 2 , … , {d}_{LDA}$$

$${R}_{M} = {\sum }_{( {j}_{1} , {j}_{2} ) ∈ {J}_{M}} ( {S}_{{j}_{1}} - {S}_{{j}_{2}} ) {( {S}_{{j}_{1}} - {S}_{{j}_{2}} )}^{T}$$

$${R}_{NM} = {\sum }_{( {j}_{1} , {j}_{2} ) ∈ {J}_{NM}} ( {S}_{{j}_{1}} - {S}_{{j}_{2}} ) {( {S}_{{j}_{1}} - {S}_{{j}_{2}} )}^{T}$$

In some example embodiments, the REVV module 120 is configured to binarize each component of the residual vector word to +1 or −1 depending on the sign. The signed binarization may create a compact image signature that just requires at most k·d_{LDA} bits. Another benefit, for example, of signed binarization is fast score computation. The inner product [symbol] S̅_{q}, S̅_{d} [symbol] may be closely approximated by the following expression

$$\frac{1}{{‖ {S}_{q} ‖}_{2} {‖ {S}_{d} ‖}_{2}} {\sum }_{i visited by Q and D} C ( {S}_{q , i}^{bin} , {S}_{d , i}^{bin} )$$

where C(S_{q,i}^{bin},S_{d,i}^{bin}) is the binary correlation, H(A,B) is Hamming distance between A and B, S_{q,i}^{bin} and S_{d,i}^{bin} are the binarized residuals for query and database images at the i-th visual word. In some example embodiments, Hamming distance can be computed quickly using a bitwise XOR, such as by the processor 110.

In some example embodiments, the REVV module 120 may be configured to apply a discriminative weighting based on correlations computed between binarized signatures. An example weighting function may include:

$$w ( C ) = \frac{P ( C \vert match )}{P ( C \vert match ) + P ( C \vert non \text{-} match )}$$

Assuming P(match)=P(non-match), then w(C)=P(match|C). In some example embodiments, using this weighting function, the score may change to:

$$\frac{1}{{‖ {S}_{q} ‖}_{2} {‖ {S}_{d} ‖}_{2}} {\sum }_{i visited by Q and D} C ( {S}_{q , i}^{bin} , {S}_{d , i}^{bin} ) \cdot w ( C ( {S}_{q , i}^{bin} , {S}_{d , i}^{bin} ) )$$

The REVV module 120 may be further configured to produce a ranked list of database candidates based on the REVV image signature. Such results may then be displayed, for example via user interface 116.

FIG. 4 illustrates an example user interface, such as user interface 116 operating on an example mobile terminal 10, which illustrates an image that has been captured by, for example, the image capture circuitry 118. In some example embodiments, a memory 112 may contain a database of a plurality of images. The database stored in the memory 112 of an example mobile terminal 10 may represent the following non exhaustive list of features, images of building in a local neighborhood as determined by GPS, images of famous landmarks and/or the like. The REVV module 120 may then be activated to perform a visual search in an instance in which a low motion period is detected, such as by the processor 110 to query the data using the contents of the image capture circuitry 118 such as in a viewfinder. Further, the visual search apparatus 102, using the processor 110, the REVV module 120 or the like, once activated, may cause a name address, and a phone number for the landmark that is determined to match the landmark captured by the image capture circuitry 118 (e.g. an image query). The user interface may include a small map, which is selectable so as to view the location of the.

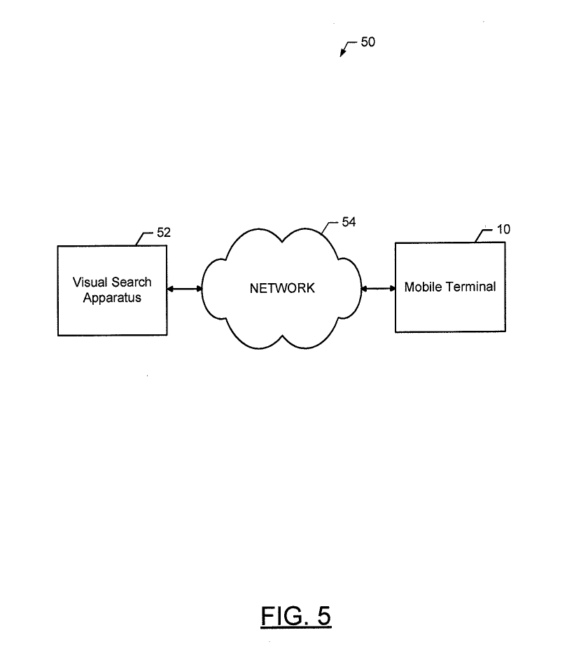

As described in conjunction with the embodiment of FIG. 1, the mobile terminal 10 may include the visual search apparatus 102. However, parts the visual search apparatus 102 may also be separated from and in communication with the mobile terminal 10, for example images, image signatures, and/or the like. FIG. 5 illustrates a system 50 for performing visual search according to an example embodiment of the invention. The system 50 comprises a visual search apparatus 52 and a mobile terminal 10 configured to communicate over the network 54. The visual search apparatus 52 may, for example, comprise an embodiment of the visual search apparatus 102 wherein the visual search apparatus 52 is embodied as one or more servers, one or more network nodes, a cloud computing system and/or the like and is configured to receive REVV image signatures generated by, for example, the REVV module 120 and is further configured to perform a low-bit-rate visual query on the one or more images stored on the visual search apparatus 52. The mobile terminal 10 may comprise any mobile terminal configured to access the network 54 and communicate with the visual search apparatus 52 in order to transmit a REVV image signature and to receive visual search results. In some example embodiments, a REVV image signature may be transmitted to the visual search apparatus 52 in an instance in which a matching image is not located on the mobile terminal 10. The network 54 may comprise a wireline network, wireless network (e.g., a cellular network, wireless local area network, wireless wide area network, some combination thereof, or the like), a direct communication link (e.g., Bluetooth, machine-to-machine communication or the like) or a combination thereof, and in one embodiment comprises the interne.

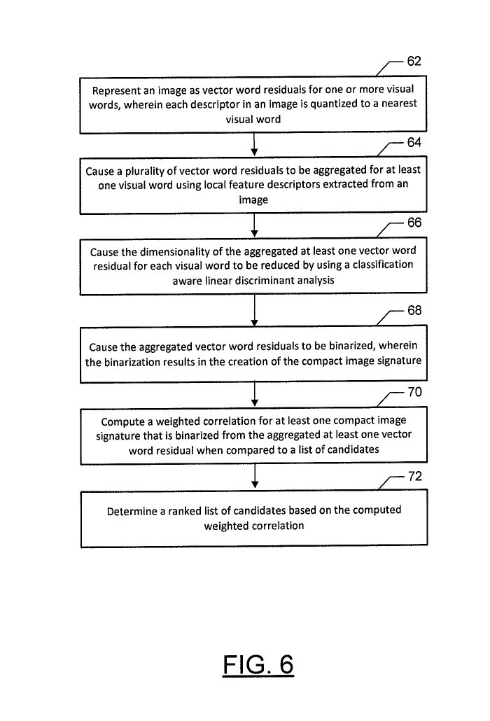

FIG. 6 illustrates an example flowchart of the example operations performed by a method, apparatus and computer program product in accordance with one embodiment of the present invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory 112 of an apparatus employing an embodiment of the present invention and executed by a processor 110 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowchart block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s). As such, the operations of FIG. 6, when executed, convert a computer or processing circuitry into a particular machine configured to perform an example embodiment of the present invention. Accordingly, the operations of FIG. 5 define an algorithm for configuring a computer or processing to perform an example embodiment. In some cases, a general purpose computer may be provided with an instance of the processor which performs the algorithms of FIG. 6 to transform the general purpose computer into a particular machine configured to perform an example embodiment.

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations herein may be modified or further amplified as described below. Moreover, in some embodiments additional optional operations may also be included. It should be appreciated that each of the modifications, optional additions or amplifications below may be included with the operations above either alone or in combination with any others among the features described herein.

FIG. 6 illustrates a flowchart according to an example method for performing REVV MVS according to an example embodiment of the invention. As shown in operation 62, the apparatus 102 may include means, such as the processor 110, the REVV module 120, or the like, for representing a captured and/or otherwise viewed image as vector word residuals for one or more visual words, wherein each descriptor in an image is quantized to a nearest visual word. As shown in operation 64, the apparatus 102 may include means, such as the processor 110, the REVV module 120, or the like, for causing a plurality of vector word residuals to be aggregated for at least one visual word using local feature descriptors extracted from an image.

As shown in operation 66, the apparatus 102 may include means, such as the processor 110, the REVV module 120, or the like, for causing the dimensionality of the aggregated at least one vector word residual for each visual word to be reduced by using a classification aware linear discriminant analysis. For example, the processor 110, the REVV module 120, or the like may cause outlier features be rejected when forming vector word residuals by discarding those features that have a distance above a predetermined percentile from a visual word and/or applying a power law to the aggregated at least one vector word residuals.

As shown in operation 68, the apparatus 102 may include means, such as the processor 110, the REVV module 120, or the like, for causing the aggregated vector word residuals to be binarized, wherein the binarization results in the creation of the compact image signature. As shown in operation 70, the apparatus 102 may include means, such as the processor 110, the REVV module 120, or the like, for computing a weighted correlation for at least one compact image signature that is binarized from the aggregated at least one vector word residual when compared to a list of candidates. As shown in operation 72, the apparatus 102 may include means, such as the processor 110, the REVV module 120, or the like, for determining a ranked list of candidates based on the computed weighted correlation.

Advantageously, example REVV modules may take advantage of a small memory footprint. The reduction of memory allows for a plurality of images to be stored locally, such as on a memory of a mobile terminal. The mobile terminal may also be in data communication with a remote server to access additional images. Alternatively or additionally, REVV modules are trained on features which are fast to extract (e.g. 1 second per query). Alternatively or additionally, the compact nature of the REVV module allows for efficient incremental updating.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
causing at least one vector word residual to be aggregated for at least one visual word using local feature descriptors extracted from an image;
causing a dimensionality of the aggregated at least one vector word residual for each visual word to be reduced using a classification aware linear discriminant analysis;
computing, using a processor, a weighted correlation for at least one compact image signature that is binarized from the aggregated at least one vector word residual when compared to a list of candidates; and
determining a ranked list of candidates based on the computed weighted correlation.

2. A method of claim 1, further comprising representing the image as vector word residuals for one or more visual words, wherein each descriptor in the image is quantized to a nearest visual word.

3. A method of claim 1, further comprising causing the aggregated at least one vector word residuals to be binarized, wherein the binarization causes a compact image signature to be created.

4. A method of claim 1, wherein the vector word residuals are aggregated based on at least one of a mean or a median of the vector word residuals.

5. A method of claim 1, further comprising causing outlier features to be rejected when forming vector word residuals by discarding those features that have a distance above a predetermined percentile from a visual word.

6. A method of claim 1, further comprising applying a power law to the aggregated at least one vector word residuals.

7. A method of claim 1, wherein the weighted correlation is weighted based on a matching likelihood ratio.

8. An apparatus comprising:
at least one processor; and
at least one memory including computer program code, the at least one memory and the computer program code configured to, with the at least one processor, cause the apparatus to at least:
cause at least one vector word residual to be aggregated for at least one visual word using local feature descriptors extracted from an image;
cause a dimensionality of the aggregated at least one vector word residual for each visual word to be reduced using a classification aware linear discriminant analysis;
compute a weighted correlation for at least one compact image signature that is binarized from the aggregated at least one vector word residual when compared to a list of candidates; and
determine a ranked list of candidates based on the computed weighted correlation.

9. An apparatus of claim 8, wherein the at least one memory including the computer program code is further configured to, with the at least one processor, cause the apparatus to represent an image as vector word residuals for one or more visual words, wherein each descriptor in an image is quantized to a nearest visual word.

10. An apparatus of claim 8, wherein the at least one memory including the computer program code is further configured to, with the at least one processor, cause the apparatus to cause the aggregated at least one vector word residuals to be binarized, wherein the binarization causes a compact image signature to be created.

11. An apparatus of claim 8, wherein the vector word residuals are aggregated based on at least one of a mean or a median of the vector word residuals.

12. An apparatus of claim 8, wherein the at least one memory including the computer program code is further configured to, with the at least one processor, cause the apparatus to cause outlier features to be rejected when forming vector word residuals by discarding those features that have a distance above a predetermined percentile from a visual word.

13. An apparatus of claim 8, wherein the at least one memory including the computer program code is further configured to, with the at least one processor, cause the apparatus to apply a power law to the aggregated at least one vector word residuals.

14. An apparatus of claim 8, wherein the weighted correlation is weighted based on a matching likelihood ratio.

15. A computer program product comprising:
at least one computer readable non-transitory memory medium having program code stored thereon, the program code which when executed by an apparatus cause the apparatus at least to:
cause at least one vector word residual to be aggregated for at least one visual word using local feature descriptors extracted from an image, wherein the vector word residuals are aggregated based on at least one of a mean or a median of the vector word residuals;
cause a dimensionality of the aggregated at least one vector word residual for each visual word to be reduced using a classification aware linear discriminant analysis;
compute a weighted correlation for at least one compact image signature that is binarized from the aggregated at least one vector word residual when compared to a list of candidates; and
determine a ranked list of candidates based on the computed weighted correlation.

16. A computer program product of claim 15, further comprising program code instructions configured to represent an image as vector word residuals for one or more visual words, wherein each descriptor in an image is quantized to a nearest visual word.

17. A computer program product of claim 15, further comprising program code instructions configured to cause the aggregated at least one vector word residuals to be binarized, wherein the binarization causes a compact image signature to be created.

18. A computer program product of claim 15, further comprising program code instructions configured to cause outlier features to be rejected when forming vector word residuals by discarding those features that have a distance above a predetermined percentile from a visual word.

19. A computer program product of claim 15, further comprising program code instructions configured to apply a power law to the aggregated at least one vector word residuals.

20. A computer program product of claim 15, wherein the weighted correlation is weighted based on a matching likelihood ratio.
